(19) United States
(12) Patent Application Publication
(10) Pub. No.: US 2008/0180621 A1
(43) Pub. Date: Jul. 31, 2008

(54) DISPLAY APPARATUS AND METHOD FOR ASSEMBLING THE SAME

(75) Inventors: Seung-Gyun WOO, Masan-si (KR); Sang-Jun PARK, Suwon-si (KR)

Correspondence Address: CANTOR COLBURN, LLP, 20 Church Street, 22nd Floor, Hartford, CT, 06103, US

(73) Assignee: SAMSUNG ELECTRONICS CO., LTD.,, Suwon-si (KR)

(21) Appl. No.: 11/957,785

(22) Filed: Dec. 17, 2007

(30) Foreign Application Priority Data
Jan. 25, 2007 (KR) 1020070007762

(51) Int. Cl. G02F 1/1333; G02F 1/13

(52) U.S. Cl. 349/138; 349/187

(57) ABSTRACT

In a display apparatus and a method for assembling the display apparatus, the display apparatus includes a display panel displaying images, a backlight unit providing light, a mold frame, a bottom chassis, a panel driving film and an insulative film. The mold frame receives the backlight unit and the display panel. The bottom chassis includes a first opening disposed under the mold frame. The panel driving film includes a plurality of driving elements and is electrically connected to the display panel. The insulative film includes an adhesive portion which is disposed between the panel driving film and the bottom chassis, and an insulating portion bent into the first opening.

### CROSS-REFERENCE TO RELATED APPLICATIONS

This application claims priority to Korean Patent Application No. 2007-7762, filed on Jan. 25, 2007, and all the benefits accruing therefrom under 35 U.S.C. §119, the contents of which are herein incorporated by reference in its entirety.

### BACKGROUND OF THE INVENTION

1. Field of the Invention

The present invention relates to a display apparatus and a method for assembling the display apparatus. More particularly, the present invention relates to a display apparatus capable of preventing electrical interference between driving elements and a bottom chassis, and capable of decreasing the total length of the display apparatus, and the method for assembling the display apparatus.

2. Description of the Related Art

A liquid crystal display (“LCD”) apparatus has merits of thin thickness, light weight, low driving voltage and low power consumption. Thus, the LCD apparatus is widely used for mobile electric devices such as mobile communication terminals.

The LCD apparatus includes an LCD panel displaying images, a panel driving film applying a driving signal to the LCD panel from an external source, a mold frame receiving the LCD panel and a bottom chassis integrally formed with the mold frame. The panel driving film is electrically connected to one side of the LCD panel and extends to a rear surface of the bottom chassis. A plurality of driving elements is disposed on the panel driving film for the driving signal to be safely applied.

The driving elements are formed on a surface of the panel driving film facing the rear surface of the bottom chassis. Accordingly, an opening is formed at the rear surface of the bottom chassis for the driving elements to be inserted into the opening. The mold frame includes a mold rib extending inside of the opening to prevent electrical interference between the driving elements and the bottom chassis. The mold rib needs to be at least more than about 0.3 millimeter (mm) in length when the mold frame is manufactured, such as via an injection molding process.

However, the mold rib is considered to be relatively longer, so that the mold rib may impede the mobile electric device from being slimmer and being more minimized (e.g., miniaturized).

### BRIEF SUMMARY OF THE INVENTION

An exemplary embodiment provides a display apparatus reducing or effectively preventing electrical interference between driving elements and a bottom chassis using an insulative film.

An exemplary embodiment provides a method for assembling the display apparatus.

In an exemplary embodiment of a display, the display apparatus includes a display panel, a bottom chassis, a panel driving film and an insulative film. The display panel displays images. The backlight unit provides light to the display panel. The mold frame receives the backlight unit and the display panel. The bottom chassis is disposed under the mold frame, and includes a first opening through a rear surface of the bottom chassis. The panel driving film is electrically connected to the display panel and extends to the rear surface of the bottom chassis. The panel driving film includes a plurality of driving elements disposed on a surface facing the rear surface of the bottom chassis and inserted into the first opening. The insulative film includes an adhesive portion which is disposed between the panel driving film and the bottom chassis and attaches the panel driving film to the bottom chassis, and an insulating portion bent into the first opening by the inserted driving elements.

In an exemplary embodiment, the bottom chassis may be integrally formed with the mold frame, such as to form a receiving container. The insulative film may include a double-sided adhesive tape. The insulating portion may include a first bending portion extending from the adhesive portion and being substantially parallel with a longitudinal direction of the first opening, and a second bending portion extending from the adhesive portion and facing the first bending portion. Total length of the first and second bending portions along a direction substantially transverse to the longitudinal direction of the first opening is substantially same as or smaller than a width of the first opening along the direction substantially transverse to the longitudinal direction of the first opening.

The insulating portion may include a second opening disposed between the first and second bending portions. An area of the second opening may be about 0.3 to about 0.7 times that of the first opening.

In an exemplary embodiment, the insulating portion may include a third bending portion extending from the adhesive portion and being substantially perpendicular to the first and second bending portions, and a fourth bending portion extending from the adhesive portion and facing the third bending portion. The second opening may have a Y-shape at sides of the third and fourth bending portions.

In an exemplary embodiment, a second opening may be formed through the insulating portion, and dimensions of the second opening may be smaller than the first opening by as much as a thickness of the bottom chassis.

In an exemplary embodiment, the mold frame may include a third opening, and an area of the third opening may be larger than that of the first opening. The mold frame may be manufactured via an injection molding process.

In an exemplary embodiment of a method for assembling the display apparatus, a panel driving film is connected to a display panel received by a mold frame and a bottom chassis integrally formed with each other. The panel driving film includes driving elements protruded towards a rear surface of the bottom chassis. An insulative film is attached to a rear surface of the bottom chassis including a first opening. An insulating portion including a second opening is formed through the insulative film, and an area of the second opening is smaller than that of the first opening. The insulating portion is bent into the first opening by bending the panel driving film toward the rear surface of bottom chassis and inserting the driving elements into the first opening through the second opening

In an exemplary embodiment, when the insulating portion is formed, a first bending portion extending from an adhesive portion may be formed to be substantially parallel with a longitudinal direction of the first opening, and a second bending portion extending from the adhesive portion may be formed to face the first bending portion. The first and second bending portions may be formed by incising the insulative film.

An exemplary embodiment of method of forming a display apparatus includes electrically connecting a driving film to a display panel. The driving film includes driving elements disposed on an inner surface of the driving film. The display panel is disposed in a receiving container including a mold frame and a bottom chassis. The bottom chassis includes a first opening. The driving film is bent to a rear side of the bottom chassis. A fixing element is attached on the rear side of the bottom chassis and between the driving film and the bottom chassis. The fixing element includes a second opening smaller than the first opening and attaches the driving film to the bottom chassis. The driving elements are inserted through the second opening of the fixing element and into the first opening of the bottom chassis from the rear side of the bottom chassis. The inserting the driving elements disposes a portion of the fixing element between the driving elements and the bottom chassis. The fixing element also reduces electrical interference between the driving elements and the bottom chassis.

In an exemplary embodiment, the insulative film is used to attach the bottom chassis with the panel driving film instead of using a conventional mold rib, so that electrical interference between the driving elements and the bottom chassis may be reduced or effectively prevented and a total thickness of the display apparatus may be decreased.

### BRIEF DESCRIPTION OF THE DRAWINGS

The above and other features and advantages of the present invention will become more apparent by describing in detailed example embodiments thereof with reference to the accompanying drawings, in which:

FIG. 1 is an exploded perspective view illustrating an exemplary embodiment of a display apparatus according to the present invention;

FIG. 2 is a perspective view illustrating an exemplary embodiment of a rear surface of the combined display apparatus of FIG. 1;

FIG. 3 is a cross-sectional view taken along line I-I′ of FIG. 2, to illustrate a panel driving film separated from a bottom chassis;

FIG. 4 is a cross-sectional view illustrating a combination of the panel driving film of FIG. 3 with the bottom chassis;

FIG. 5 is a plan view illustrating an exemplary embodiment of an insulative film of FIG. 4 including an insulating portion according to the present invention;

FIG. 6 is a plan view illustrating another exemplary embodiment of an insulative film of FIG. 4 including an insulating portion according to the present invention;

FIG. 7 is a plan view illustrating another exemplary embodiment of an insulative film of FIG. 4 including an insulating portion according to the present invention; and

FIGS. 8A, 8B and 8C are cross-sectional views illustrating an exemplary embodiment of a process of assembling the display apparatus according to the present invention.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower,” “under,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “lower” other elements or features would then be oriented “above” the other elements or features. Thus, the term “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be explained in detail with reference to the accompanying drawings.

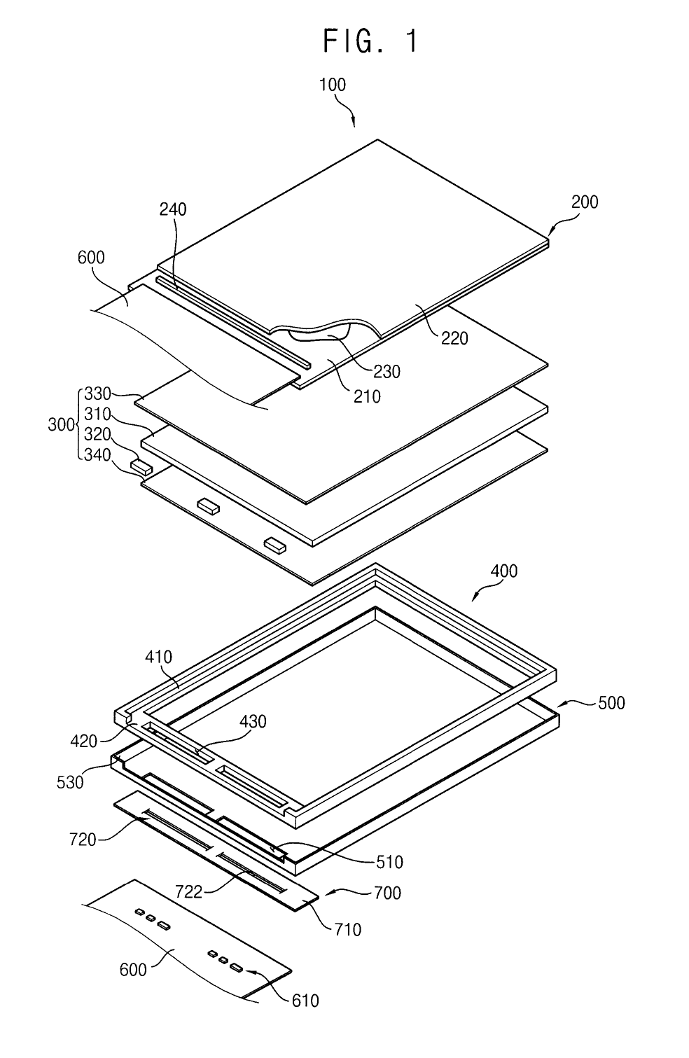

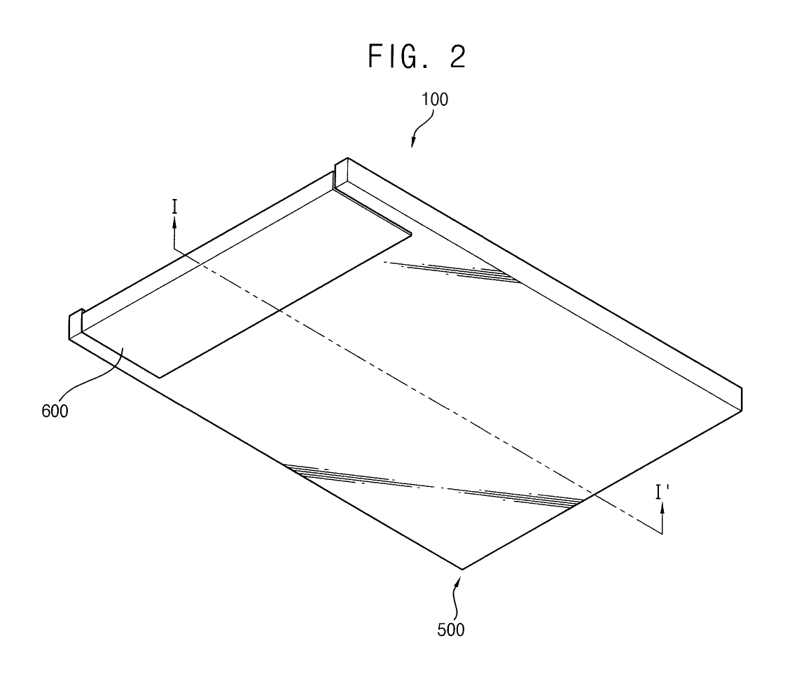

FIG. 1 is an exploded perspective view illustrating an exemplary embodiment of a display apparatus 100 according to the present invention. FIG. 2 is a perspective view illustrating an exemplary embodiment of a rear surface of the combined display apparatus 100 of FIG. 1.

Referring to FIGS. 1 and 2, the display apparatus 100 includes a display panel 200, a backlight unit 300, a mold frame 400, a bottom chassis 500, a panel driving film 600 and a fixing element 700. Hereinafter, the fixing element 700 may also be referred to as an insulative film.

The display panel 200 displays images. The display panel 200 includes a first substrate 210 and a second substrate 220 facing the first substrate 210. The first substrate 210 may be a thin-film transistor (“TFT”) substrate on which a TFT is formed in a substantially matrix shape. The second substrate 220 may be a color filter substrate on which a red-green-blue (“RGB”) pixel displaying color is formed in a thin-film shape. In exemplary embodiments, the first and second substrates 210 and 220 include a transparent glass material transmitting light.

In an exemplary embodiment, the display panel 200 may further include a liquid crystal layer 230 disposed between the first and second substrates 210 and 220. The liquid crystal layer 230 includes a plurality of liquid crystal molecules (not shown). The liquid crystal molecules have birefringence characteristics. In addition, an arrangement of the liquid crystal molecules changes according to an electric field applied from an external source. The display panel 200 changes the light passing through the liquid crystal molecules, to display predetermined images. In exemplary embodiments, the light may be external light applied from the external source, and/or the light may be internal light provided from the backlight unit 300 disposed at a side of the display panel 200.

Alternatively, the display panel 200 may include an organic light-emitting layer that is disposed between the first and second substrates 210 and 220 and emits the light by itself. The organic light-emitting layer may emit white light mixed with red light, green light and blue light. Alternatively, the organic light-emitting layer may sequentially emit the red light, the green light and the blue light according to position. In this case, the RGB pixel does not need to be formed on the second substrate 220.

The display panel 200 includes a driving chip 240. The driving chip 240 is disposed at a side of the first substrate 210, such as near an end of a transverse side and substantially parallel with the transverse side. For example, the end of the first substrate 210, where the driving chip 240 is disposed, may extend further than a corresponding end of the second substrate 220 by a predetermined distance, such that the first substrate 210 is larger (e.g., in a longitudinal direction) than the second substrate 220. The driving chip 240 applies a control signal to the first and second substrates 210 and 220. The control signal is generated through a driving signal applied from the external source. The driving signal may be applied to the display panel 200 through the panel driving film 600. As used herein, “corresponding” may indicate corresponding substantially in shape, size or positional placement relative to another element.

The backlight unit 300 provides the light to the display panel 200. The backlight unit 300 includes a light-guide plate 310, a light source 320, an optical sheet 330 and a reflective sheet 340. The light-guide plate 310 is disposed to face the first substrate 210. The light-guide plate 310 may include a transparent material to guide the light. The light source 320 is disposed at an incident side of the light-guide plate 310 to emit the light to the light-guide plate 310.

In an exemplary embodiment, the light source 320 may include a light-emitting diode (“LED”) emitting the light to a direction, such as using characteristics of a semiconductor. Alternatively, the light source 320 may include a cold cathode fluorescent light (“CCFL”) having a substantially cylindrical shape to emit the light to essentially all directions.

The optical sheet 330 is disposed between the light-guide plate 310 and the display panel 200. The optical sheet 330 enhances optical characteristics of the light emitted from the light-guide plate 310. The light-guide plate 310 is disposed between the reflective sheet 340 and the optical sheet 330. The reflective sheet 340 reflects the light leaking from the light-guide plate 310 towards the display panel 200.

The mold frame 400 has a substantially rectangular loop (e.g., frame) shape, supports the display panel 200 and receives the display panel 200 and the backlight unit 300. In an exemplary embodiment, the mold frame 400 may include a panel support portion 410 which inwardly protrudes and supports the display panel 200, such as at its peripheral edges. In one exemplary embodiment, the mold frame 400 includes a resin material having good processibility.

The panel support portion 410 is formed at inner sides of the mold frame 400. As in the illustrated embodiment, the panel support portion 410 extends from inner surfaces of four sides of the mold frame 400 and substantially parallel with a lower surface of the display panel 200. Driving elements 610 of the panel driving film 600 may be disposed at an end of the panel support portion 410 corresponding to the driving chip 240 of the display panel 200.

As in the illustrated embodiment, the portion of the panel support portion 410 corresponding to end of the first substrate 210 where the driving chip 240 is disposed, extends further inside than the panel support portion 410 corresponding to the other three sides. The panel support portion 410 corresponding to the driving chip 240 is referred to as a driving element disposing portion 420. Since images are not substantially displayed through a portion of the first substrate 210 on which the driving chip 240 is disposed, the driving element disposing portion 420 is extended inward as far as and corresponding to the extended length of the first substrate 210, such as to dispose the driving chip 240 on the driving element disposing portion 420.

The bottom chassis 500 is integrally formed with the mold frame 400, e.g., formed to be a single unit. The bottom chassis 500 may include a metal material. In one exemplary embodiment, the bottom chassis 500 may include a stainless steel material. The bottom chassis 500 enhances strength of the mold frame 400 and maintains an external shape of the mold frame 400. Alternatively, the bottom chassis 500 may include an aluminum material, such as to make the display device 100 relatively lighter.

A first opening 510 is formed through the rear surface of the bottom chassis 500. The driving elements 610 of the panel driving film 600 are disposed in the first opening 510, such as being inserted from a rear side of the bottom chassis 500. As in the illustrated embodiment, more than one of the first openings 510 may be disposed lengthwise, e.g., in a transverse direction of the bottom chassis 500 to accommodate the driving elements 610. Alternatively, one first opening 510 may be disposed lengthwise in the transverse direction to include all of the driving elements 610.

The bottom chassis 500 may be manufactured using a molding process. The mold frame 400 may be manufactured using an injection molding process based on the bottom chassis 500. In one exemplary embodiment, the bottom chassis 500 including the first opening 510 formed through the rear surface of the bottom chassis 500, is manufactured using a die and mold. The bottom chassis 500 is disposed in the die and mold having a shape of the mold frame 400. Liquid resin is injected into the die and mold. Additives may be coated on the bottom chassis 500 to enhance affinity to the liquid resin. When the liquid resin is hardened after a period of time, the mold frame 400 and the bottom chassis 500 are separated from the die and mold, to complete the mold frame 400 and the bottom chassis 500 integrated with each other.

Advantageously, when the mold frame 400 and the bottom chassis 500 are integrally formed, a space between the mold frame 400 and the bottom chassis 500 is removed to minimize a total thickness of the mold frame 400 and the bottom chassis 500, such as in a vertical direction. In addition, the mold frame 400 and the bottom chassis are combined with each other more securely, so that the strength of the display apparatus 100 may be enhanced.

The panel driving film 600 is electrically connected to the display panel 200 at a first end. As in the illustrated embodiment, the panel driving film 600 is electrically connected to an end portion of the first substrate 210 of the display panel 200 on which the driving chip 240 is disposed. The panel driving film 600 has flexibility to be relatively easily bent. A second end of the panel driving film 600 is bent to the rear surface of the bottom chassis 500.

The panel driving film 600 is electrically connected to an external control part (not shown) to apply the driving signal to the driving chip 240. In the illustrated embodiment, the plurality of driving elements 610 is disposed on the panel driving film 600 to provide the driving signal safely, and to reduce or effectively prevent malfunction.

When the panel driving film 600 is bent from the display panel 200 towards the rear surface of the bottom chassis 500, the driving elements 610 are disposed to face the rear surface of the bottom chassis 500 of the panel driving film 600. The driving elements 610 protruding from a lower surface of the panel driving film 600 are inserted into the first opening 510 of the bottom chassis 500 from the rear side of the bottom chassis 500. In one exemplary embodiment, the driving elements 610 may include one of a resistor, a capacitor and a diode. The driving elements 610 may be relatively closely disposed and/or be grouped such as to minimize a size of the first opening 510.

The driving elements 610 may malfunction due to electrical interference by conductive materials around the driving elements 610. For example, when the driving elements 610 suffer from the electrical interference, the driving signal may be unstable, so that images may be falsely displayed in the display panel 200. In this case, the conductive material causing the malfunction to the driving elements 610 may be the bottom chassis 500 including the first opening 510. To prevent the malfunction, a mold rib formed from the mold frame is conventionally used, adding to the overall thickness of the display apparatus. However, in the illustrated embodiment according to the present invention, an insulative film 700 is used to reduce or effectively prevent malfunction of the driving element 610 from electrical interference. Advantageously, the insulative film 700 is also used to attach the panel driving film 600 to the bottom chassis 500, thereby reducing the overall thickness of the display apparatus 100.

The insulative film 700 is disposed between the panel driving film 600 and the bottom chassis 500. Particularly, the insulative film 700 attaches the panel driving film 600 on the rear surface of the bottom chassis 500. In an exemplary embodiment, the insulative film 700 may substantially include a double-sided adhesive tape having thin thickness, insulation and double-sided adhesiveness properties.

The insulative film 700 may substantially include a fixing portion 710 attached to the panel driving film 600 and on the rear surface of the bottom chassis 500, and an insulating portion 720 that may prevent electrical interference between the bottom chassis 500 and the driving elements 610 disposed in the first opening 510. Hereinafter, the fixing portion 710 may also be referred to as an adhesive portion.

An area of the adhesive portion 710 is substantially the same as an area of the panel driving portion 600 overlapping with and disposed on the bottom chassis 500. Alternatively, the area of the adhesive portion 710 may be slightly larger or slightly smaller than that of the panel driving film 600 disposed on the rear surface of the bottom chassis 500.

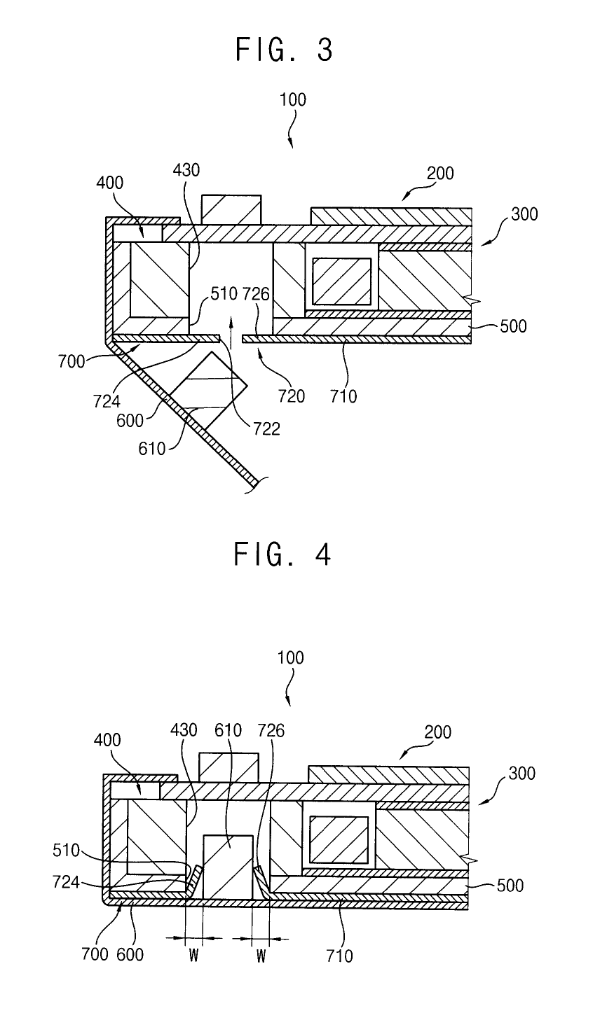

In an exemplary embodiment, the insulating portion 720 may be formed by incising or removing a portion of the insulating portion 720 corresponding to the first opening 510. As illustrated in FIG. 1, a second opening 722 may be formed through the insulating portion 720, and the area of the second opening 722 is smaller than that of the first opening 510. The insulating portion 720 is a portion of the fixing element 700 extending from edges of the first opening 510 in the bottom chassis 500 to the second opening 722 of the fixing member. The remainder of the fixing element 700 up to the edges of the first opening 510 may be considered the adhesive portion 710. The insulating portion 720 is bent by the driving elements 610, when the driving elements 610 are inserted into the first opening 510. (See FIG. 3.)

Advantageously, the insulative film 700 that is used for attaching the bottom chassis 500 with the panel driving film 600 is used instead of the conventional mold rib, to reduce or effectively prevent the electrical interference between the driving elements 610 and the bottom chassis 500.

Since the conventional mold rib is omitted, the total thickness of the display apparatus may be decreased. Particularly, the mold rib may have a thickness of at about 0.3 mm. Thus, two conventional mold ribs would be substantially formed in the opening 510, so that a total thickness of at least about 0.6 mm would be added to the display apparatus.

As in the illustrated in FIG. 1, when the mold ribs are omitted and the insulative film is used for both attaching the bottom chassis 500 and panel driving film 600 to each other, as well as reducing or effectively prevent the electrical interference between the driving elements 610 and the bottom chassis 500, a thickness of the display apparatus 100 may be reduced by at least about 0.6 mm due to the elimination of the conventional mold ribs. The thickness of at least about 0.6 mm may be a relatively very important factor in designing the display apparatus.

The mold frame 400 includes a third opening 430 corresponding to the first opening 510. The third opening 430 is formed through the driving element disposing portion 420 of the mold frame 400. When the driving elements 610 are combined with the mold frame 400, the driving elements are sequentially inserted through the second opening 722 of the fixing member 700, the first opening 510 of the bottom chassis 500 and the third opening 430 of the mold frame 400.

FIG. 3 is a cross-sectional view taken along line I-I′ of FIG. 2, to illustrate the panel driving film 600 separated from the bottom chassis 500. FIG. 4 is a cross-sectional view illustrating a combination of the panel driving film 600 of FIG. 3 with the bottom chassis 500. FIG. 5 is a plan view illustrating an exemplary embodiment of the insulative film 700 of FIG. 4 including the insulating portion 720.

Referring to FIGS. 3, 4 and 5, the insulating portion 720 of the insulative film 700 includes a first bending portion 724 and a second bending portion 726. The first and second bending portions 724 and 726 are extended from an edge of the first opening 510 towards the second opening 722, in a direction substantially transverse to a longitudinal direction of the first opening 510.

Referring to FIG. 5, the first bending portion 724 extends from the adhesive portion 710 in a transverse direction of the first opening 510. A first longitudinal side of the first bending portion 724 extends to be substantially parallel with the longitudinal direction of the first opening 510. Particularly, the first longitudinal side of the first bending portion 724 extends from the adhesive portion 710 corresponding to a relatively longer side of the sides of the first opening 510. The first side of the first bending portion 724 (e.g., a longitudinal side) corresponding to a side of the first opening 510 (e.g., a longitudinal side) is connected to the adhesive portion 710. A second longitudinal side of the first bending portion 724 is disposed opposite to the first longitudinal side and proximate to the second opening 722.

The second bending portion 726 extends from the adhesive portion 710 in a transverse direction of the first opening 510. A first longitudinal side of the second bending portion 726 extends to be substantially parallel with the longitudinal direction of the first opening 510. A second longitudinal side of the second bending portion 726 opposing the first longitudinal side faces the second longitudinal side of first bending portion 724, e.g., across the second opening 722. Particularly, the first longitudinal side of the second bending portion 726 extends from the adhesive portion 710 corresponding to a relatively longer side of the sides of the first opening 510. The first side of the second bending portion 726 corresponding to a side of the first opening 510 is connected to the adhesive portion 710, in a similar manner as the first bending portion 724 described above. As in the illustrated embodiment, the second bending portion 726 may have substantially the same shape and dimensions as the first bending portion 724, except that positions of the sides connected to the adhesive portion 710 are different from each other.

The first and second bending portions 724 and 726 are bent along the first longitudinal sides indicated by a dotted line in FIG. 5. Transverse sides of the first and second bending portions 724 and 726 connecting the first and second longitudinal sides, respectively, are separated from the adhesive portion 710 when the first and second bending portions 724 and 726 are bent into the first opening 510.

The first and second bending portions 724 and 726 extending from the adhesive portion 710 are disposed to partially cover the first opening 510. The second opening 722 formed through the insulating portion 720 defines a space between the facing first and second bending portions 724 and 726. In exemplary embodiments, the second opening 722 may have an I-shape or a Y-shape.

An area of the second opening 722 is substantially smaller than that of the first opening 510 of the bottom chassis 500. In exemplary embodiments, the area of the second opening 722 may be about 0.3 to about 0.7 times that of the first opening 510. In one exemplary embodiment, the area of the second opening 722 may be about 0.5 times that of the first opening 510.

The second opening 722 may be formed to have the area mentioned above, in forming the insulative film 700. Alternatively, when the first opening 510 has a very small area, the second opening 722 may be formed to have the area in proportion to the first opening 10 mentioned above by incising the insulative film 700. The incision of the insulative film 700 may use additional incision tools after tightly attaching the insulative film 700 to the bottom chassis 500.

Referring to FIG. 4, the first and second bending portions 724 and 726 are bent into the first opening 510 of the bottom chassis 500 and the third opening 430 of the mold frame 400 by the driving elements 610 of the panel driving film 600, when the panel driving film 600 is combined with the bottom chassis 500. The first and second bending portions 724 and 726 bent into the first and third openings 510 and 430, are disposed between the bottom chassis 500 and the driving elements 610.

A distance ‘W’ between the driving elements 610 and the bottom chassis 500 is substantially large enough at so that the electrical interference between the driving elements 610 and the bottom chassis 500 may be negligible, or effectively prevented. Distance ‘W’ is taken substantially perpendicular from a side of the first opening 510 to a vertical side the driving elements 610. The side of the bottom chassis 500 at the first opening 510 is substantially perpendicular to the first and second bending portions 724 and 726 (e.g., unbent, FIG. 3). The first and second bending portions 724 and 726 essentially bend along a lower corner edge of this side of the bottom chassis 500 so as to be disposed in the first opening 510 (FIG. 4).

The first opening 510 is dimensioned to have a predetermined space between the driving elements 610 and the bottom chassis 500, such that the driving elements 610 can be relatively easily inserted into the first opening 510. In exemplary embodiments, width ‘W’ of the predetermined space may be between about 0.2 mm and about 0.4 mm. In one exemplary embodiment, the dimension ‘W’ may be about 0.3 mm. As illustrated in FIG. 4, the first and second bending portions 724 and 726 may be bent to be disposed in the predetermined space.

Advantageously, the insulative film 700 may reduce or effectively prevent the electrical interference between the bottom chassis 500 and the driving elements 610 in the first opening 510 through the first and second bending portions 724 and 726 of the insulating portion 720. For example, the insulating portion 720 may prevent the malfunction of the driving elements 610 due to an electrical short of the bottom chassis 500 and the driving elements 610.

In addition, the insulating portion 720 according to the present invention may be formed by merely incising the insulative film 700 in the first opening 510 without requiring additional elements to be assembled for the display apparatus 100, so that working hours and costs for manufacturing the display apparatus may be decreased.

The third opening 430 of the mold frame 400 may be dimensioned substantially the same as a total area of the first opening 510 of the bottom chassis 500. In an exemplary embodiment, a side (e.g., edge) of the third opening 430 may be in a line with the side of the first opening 510, such as in a plan view. Alternatively, an edge of the third opening 430 may be formed outside of the side of the first opening 510, such as in a plan view. When the edge of the third opening 430 is formed outside of the first opening 510, the side of the first opening 510 can be seen on an inside of the third opening 430 in a plan view.

Alternatively, the side of the third opening 430 may be formed inside of the side of the first opening 510 due to the injection molding process of the mold frame 400. The side of the third opening 430 may be a burr formed during the injection molding process of the mold frame 400, and a thickness of the burr may be about 0.05 mm. When the burr is arbitrarily formed around the side of the first opening 510, the electrical interference between the bottom chassis 500 and the driving elements 610 in the first opening 510 may be prevented by the burr. In this case, the thickness of the burr, which is about 0.05 mm, is much smaller than a space for the driving elements 610 to be inserted, which is about 0.3 mm, and thus a total length of the display apparatus 100 may not be affected or increased.

In an exemplary embodiment, an additional insulating coating layer may be formed on the bottom chassis 500 corresponding to the side of the opening 510, so that the electrical interference between the bottom chassis 500 and the driving elements 610 may be further reduced or effectively prevented. The insulating coating layer may include a silicone material having good workability and insulation. Alternatively, the insulating coating layer may be formed on portions of the driving elements 610 facing the bottom chassis 500 in the first opening 510. A thickness of the insulating layer in a direction perpendicular to a part of the bottom chassis 500 facing the driving elements 610, may be at least about 0.05 mm. The thickness of the insulating layer, which is about 0.05 mm, is much smaller than a space for the driving elements 610 to be inserted, which is about 0.3 mm, and thus the total length of the display apparatus 100 may not be affected or increased.

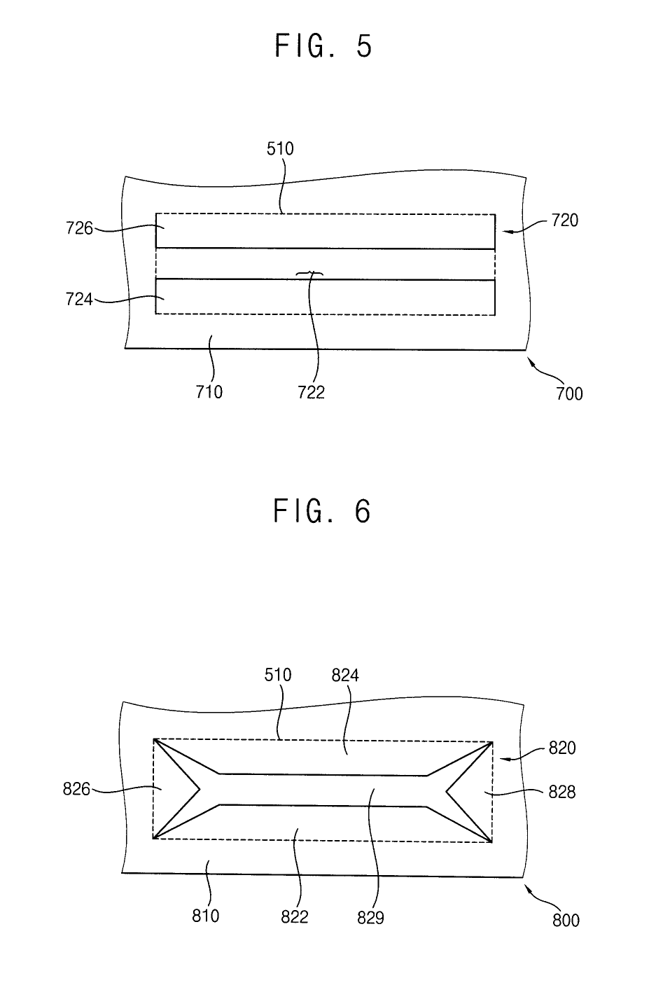

FIG. 6 is a plan view illustrating another exemplary embodiment of an insulative film of FIG. 4 including an insulating portion 820 according to the present invention.

The insulative film of FIG. 6 is the same as in FIG. 4 except the insulating portion. Thus, any further explanation concerning the above elements will be omitted.

Referring to FIGS. 4 and 6, the insulating portion 820 of an insulative film 800 according to the present exemplary embodiment includes a first bending portion 822 and a second bending portion 824, and further includes a third bending portion 826 and a fourth bending portion 828.

The third bending portion 826 extends from an adhesive portion 810 in a direction substantially perpendicular to the first and second bending portions 822 and 824. The third bending portion 826 extends from a transverse edge of the adhesive portion 810 corresponding to a first (e.g., transverse) side of the first opening 510. A first side of the third bending portion 826 corresponds to the transverse side of the first opening 510 and is connected to the adhesive portion 810. In the illustrated embodiment, the third bending portion 826 has a triangular shape and a base of the triangle may be considered as the first side of the third bending portion 826.

The fourth bending portion 828 extends from the adhesive portion 810 in a direction substantially parallel to a longitudinal direction of the first opening 510 and to face the third bending portion 826. The fourth bending portion 828 extends from a transverse edge of the adhesive portion 810 corresponding to a second (e.g., transverse) side of the first opening 510. A first side of the fourth bending portion 828 corresponds to the transverse side of the first bending portion 510 and is connected to the adhesive portion 810. In the illustrated embodiment, the fourth bending portion 828 has a triangular shape and a base of the triangle may be considered as the first side of the fourth bending portion 828.

The fourth bending portion 828 may have substantially the same shape as the third bending portion 826 except that an edge of the fourth bending portion 828 connected to the adhesive portion 810 is different from that of the third bending portion 826.

The third and fourth bending portions 826 and 828 are bent into the first opening 510 in addition to the first and second bending portions 822 and 824 when driving elements 610 are inserted into the first opening 510 of the bottom chassis 500. The third and fourth bending portions 826 and 828 reduce or effectively prevent electrical interference between the driving elements 610 and the bottom chassis 500 in a direction perpendicular to the first and second bending portions 822 and 824 bent into the first opening 510.

In exemplary embodiments, when a length of the first opening 510 is relatively large, the third and fourth bending portions 826 and 828 become more significant in reducing or effectively preventing the electrical interference.

Referring again to FIG. 6, the insulating portion 820 includes a second opening 829 formed between the first, second, third and fourth bending portions 822, 824, 826 and 828. The second opening 829 is considered to have a Y-shape at inclined sides of the third and fourth bending portions 826 and 828. The inclined sides of the third and fourth bending portions 826 and 828 face inclined sides of the first and second bending portions 822 and 824. Thus, the first, second, third and fourth bending portions 822, 824, 826 and 828 are prevented from overlapping with each other. When the first, second, third and fourth bending portions 822, 824, 826 and 828 including the inclined portions are bent into the first opening 510, the first, second, third and fourth bending portions 822, 824, 826 and 828 do not interfere with each other. The first, second, third and fourth bending portions 822, 824, 826 and 828 are bent along the lines indicated by a dotted line in FIG. 6 when the driving elements 610 are inserted into the first opening 510 with the driving elements 610.

In an exemplary embodiment, the second opening 829 may be formed via incising the insulative film 800 using additional incision tools after tightly attaching the insulative film 800 to the bottom chassis 500.

Advantageously, the insulative film 800 further includes the third and fourth bending portions 826 and 828 substantially perpendicular to the first and second bending portions 822 and 824, such that a gap between the driving elements 610 and the bottom chassis 500 may be effectively completely insulated. The insulative film 800 including the first, second, third and fourth bending portions 822, 824, 826 and 828 essentially completely block electrical contact between the driving elements 610 and the bottom chassis 500.

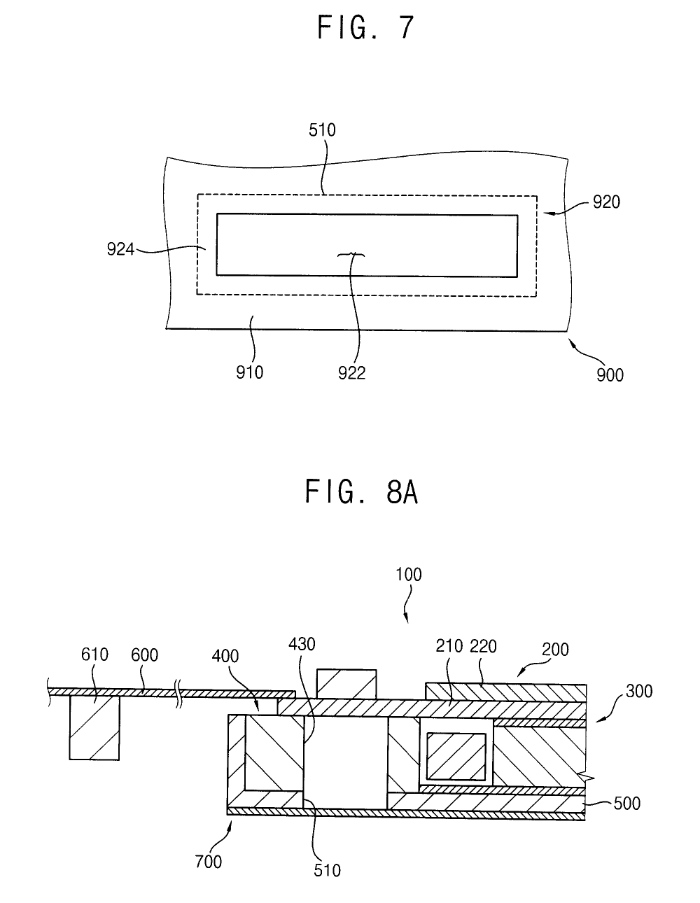

FIG. 7 is a plan view illustrating another exemplary embodiment of an insulative film of FIG. 4 including an insulating portion 920 according to the present invention.

The insulative film of FIG. 7 is the same as in FIG. 4 except the insulating portion. Thus, any further explanation concerning the above elements will be omitted.

Referring to FIGS. 4 and 7, a second opening 922 is formed through the insulating portion 920 of an insulative film 900. Dimensions of the second opening 922 are smaller by a thickness of the bottom chassis 500, compared with dimensions of the first opening 510. Edges of the first opening 510 are shown by a dotted line in FIG. 7. Edges of the second opening 922 are shown inside of the edges of the first opening 510, whereby the dimensions (e.g., length and width) of the second opening 922 are smaller than those dimensions of the first opening 510. The second opening 922 is formed to substantially correspond to a shape of the first opening 510.

In an exemplary embodiment, a thickness of the bottom chassis 500 in a vertical direction (e.g., a height of a sidewall) may be between about 0.1 mm and about 0.2 mm. In one exemplary embodiment, the thickness of the bottom chassis 500 may be about 0.15 mm as in a slim version of the display apparatus 100. For example, dimensions of sides of the second opening 922 may be smaller than those of the first opening 510 by about 0.15 mm.

The insulating portion 920 extends inwardly towards the second opening 922 by about 0.15 mm from an adhesive portion 910 with respect to an outline of the second opening 922. The insulating portion 920 includes a bending portion 924 that is bent into first opening 510 by the driving elements 610 and is disposed between the bottom chassis 500 and the driving elements 610. In an exemplary embodiment, when the driving elements 610 are inserted into the first opening 510, the bending portion 924 may deform or separate on diagonals of corners, thereby allowing individual parts of the bending portion 924 (e.g., two transverse parts and two longitudinal parts) to be inserted into the first opening 510.

Advantageously, the insulating portion 920 reduces or substantially prevents the electrical interference between the driving elements 610 and the bottom chassis 500 through the bending portion 924. Alternatively, the second opening 922 may be smaller by slightly more than about 0.15 mm (e.g., the thickness of the bottom chassis 500), to inwardly extend the bending portion 924 further.

For example, when the driving elements 610 are inserted into the second opening 922, the four sides of the bending portion 924 may be bent toward the first opening 510 and may be pushed into the first opening 510 by the driving elements 610.

As illustrated in FIG. 7, the second opening 922 has substantially the same center as the first opening 510. Alternatively, when the insulating portion 920 is bent into the first opening 510 to reduce or effectively prevent the electrical interference between the driving elements 610 and the bottom chassis 500, the second opening 922 may have a substantially different center from the first opening 510. In an exemplary embodiment, the second opening 922 may be formed with the insulative film 900 at the same time.

Advantageously, the insulative film 900 includes the insulating portion 920 in which the second opening 922 has smaller dimensions in comparison with the first opening 510, to reduce or effectively prevent the electrical interference between the bottom chassis 500 and the driving elements 610.

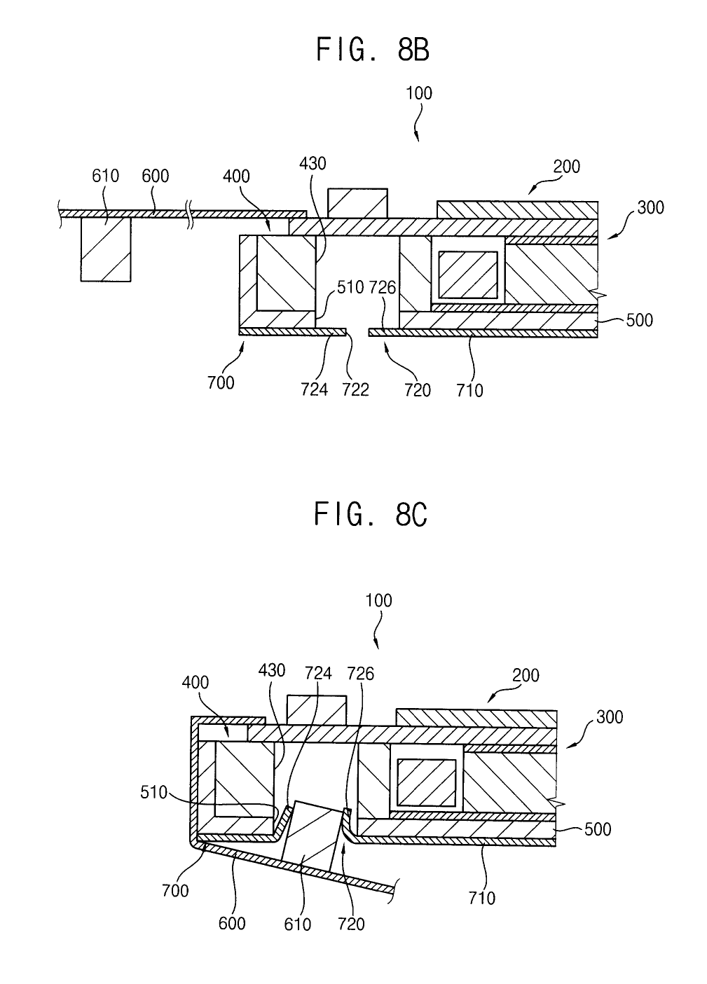

FIGS. 8A, 8B and 8C are cross-sectional views illustrating an exemplary embodiment of a process of assembling the display apparatus 100 according to the present invention.

Referring to FIG. 8A, the backlight unit 300 and the display panel 200 are received in the mold frame 400 and the bottom chassis 500. The mold frame 400 and the bottom chassis 500 are integrally formed with each other. The panel driving film 600 is electrically connected to a side (e.g., peripheral) portion of the first substrate 210 of the display panel 200. In the illustrated embodiment, the driving elements 610 are relatively closely disposed on the panel driving film 600. The driving elements 610 are disposed along a transverse direction of the bottom chassis 500 and of the panel driving film 600. The first opening 510 may be formed through the bottom chassis 500 for the driving elements 610 to be disposed therein, such as from a rear side of the bottom chassis 500.

The insulative film 700 is tightly attached to the rear surface of the bottom chassis 500. The insulative film 700 attaches the panel driving film 600 to the bottom chassis 500. In one exemplary embodiment, the insulative film 700 may substantially include a double-sided adhesive tape having thin thickness and flexibility.

Referring to FIG. 8B, the insulating portion 720 includes the second opening 722 of relatively smaller area to that of the first opening 510. The insulating portion 720 is formed to be bent into the first opening 510 when the driving elements 610 are inserted into the first opening 510. In an exemplary embodiment, the second opening 722 of the insulating portion 720 may be formed via incising the insulative film 700 with additional incision tools. The insulating portion 720 may include the first and second bending portions 724 and 726 facing each other and extending in a longitudinal direction parallel with the longitudinal direction of the first opening 510.

Referring to FIG. 8C, the panel driving film 600 is bent to the rear surface of the bottom chassis 500 and is disposed on the rear surface of the bottom chassis 500. The driving elements 610 are inserted into the first opening 510 through the second opening 722. The driving elements 610 are dimensioned larger than the opening 722. When the driving elements 610 are inserted into the first opening 510, the insulating portion 720 is bent into the first opening 510 by the driving elements 610. When the driving elements are disposed in the first opening 510, the first and second bending portions 724 and 726 of the insulating portion 720 may be disposed between the driving elements 610 and the bottom chassis 500. The insulating portion 720 electrically protects the driving elements 610 from the bottom chassis 500.

The driving elements 610 are completely inserted into the first opening 510 and the panel driving film 600 is attached to the insulative film 700, to complete the assembly of the display apparatus 100, as illustrated in FIG. 4.

As in the illustrated embodiments, the insulative film is used to attach the bottom chassis with the panel driving film instead of using a conventional mold rib, so that the electrical interference between the driving elements and the bottom chassis may be reduced or effectively prevented. Advantageously, a total thickness of the display apparatus may be decreased using the insulative film to protect against electrical interference and attach the panel driving film to the bottom chassis.

In an illustrated embodiment, the insulating portion may be formed via incising the insulative film in the opening of the bottom chassis, so that the assembly process may be simplified.

Having described the exemplary embodiments of the present invention and its advantages, it is noted that various changes, substitutions and alterations can be made herein without departing from the spirit and scope of the invention as defined by appended claims.

What is claimed is:

1. A display apparatus comprising:
a display panel displaying images;
a backlight unit providing light to the display panel;
a mold frame receiving the backlight unit and the display panel;
a bottom chassis disposed under the mold frame, and including a first opening through a rear surface of the bottom chassis;
a panel driving film electrically connected to the display panel, extending to the rear surface of the bottom chassis, and including a plurality of driving elements disposed on a surface of the panel driving film facing the rear surface of the bottom chassis, the driving elements inserted into the first opening; and
an insulative film including an adhesive portion disposed between the panel driving film and the bottom chassis, and attaching the panel driving film to the bottom chassis, and an insulating portion bent into the first opening by the inserted driving elements.

2. The display apparatus of claim 1, wherein the bottom chassis is integrally formed with the mold frame.

3. The display apparatus of claim 2, wherein the insulative film comprises a double-sided adhesive tape.

4. The display apparatus of claim 3, wherein the insulating portion comprises:
a first bending portion extending from the adhesive portion and being substantially parallel with a longitudinal direction of the first opening; and
a second bending portion extending from the adhesive portion and facing the first bending portion.

5. The display apparatus of claim 4, wherein total length of the first and second bending portions along a direction substantially transverse to the longitudinal direction of the first opening is substantially same as or smaller than a width of the first opening along the direction substantially transverse to the longitudinal direction of the first opening.

6. The display apparatus of claim 4, wherein the insulating portion comprises a second opening formed between the first and second bending portions.

7. The display apparatus of claim 6, wherein an area of the second opening is about 0.3 to about 0.7 times that of the first opening.

8. The display apparatus of claim 6, wherein the insulating portion comprises:
a third bending portion extending from the adhesive portion and being substantially perpendicular to the first and second bending portions; and
a fourth bending portion extending from the adhesive portion and facing the third bending portion.

9. The display apparatus of claim 8, wherein the second opening has a Y-shape at sides of the third and fourth bending portions.

10. The display apparatus of claim 3, wherein a second opening is formed through the insulating portion, and a width of the second opening is smaller than a corresponding width of the first opening by as much as a thickness of the bottom chassis.

11. The display apparatus of claim 2, wherein the mold frame comprises a third opening, and an area of the third opening is larger than that of the first opening.

12. The display apparatus of claim 11, wherein the mold frame is manufactured via an injection molding process.

13. A method for assembling a display apparatus, the method comprising:
connecting a panel driving film to a display panel received in a mold frame and a bottom chassis integrally formed with each other, the panel driving film including driving elements protruded towards a rear surface of the bottom chassis;
attaching an insulative film to the rear surface of the bottom chassis including a first opening;
forming an insulating portion including a second opening in the insulative film, an area of the second opening being smaller than that of the first opening; and
bending the insulating portion into the first opening by bending the panel driving film toward the rear surface of bottom chassis and inserting the driving elements into the first opening of the bottom chassis through the second opening in the insulative film.

14. The method of claim 13, wherein the forming an insulating portion comprises:
forming a first bending portion extending from an adhesive portion of the insulative film and to be substantially parallel with a longitudinal direction of the first opening; and
forming a second bending portion extending from the adhesive portion of the insulative film and to face the first bending portion.

15. The method of claim 14, wherein the first and second bending portions are formed by incising the insulative film.

16. The method of claim 13, wherein the mold frame is manufactured via an injection molding process.

17. A method of forming a display apparatus, the method comprising:
electrically connecting a driving film to a display panel, the driving film including driving elements disposed on an inner surface of the driving film;
disposing the display panel in a receiving container including a mold frame and a bottom chassis, the bottom chassis including a first opening;
bending the driving film to a rear side of the bottom chassis;
attaching a fixing element on the rear side of the bottom chassis and between the driving film and the bottom chassis, the fixing element including a second opening smaller than the first opening and attaching the driving film to the bottom chassis;
inserting the driving elements through the second opening of the fixing element and into the first opening of the bottom chassis from the rear side of the bottom chassis, the inserting the driving elements disposing a portion of the fixing element between the driving elements and the bottom chassis, the fixing element reducing electrical interference between the driving elements and the bottom chassis.

18. The method of claim 17, wherein attaching the fixing element includes incising the insulative film and forming the second opening after the fixing element is attached to the bottom chassis.

19. The method of claim 17, wherein the disposing a portion of the fixing element includes disposing a first bending portion and a second bending portion of the fixing element between the driving elements and the bottom chassis, each of the first and second bending portions being longitudinally extended parallel to a longitudinal side of the first opening.

20. The method of claim 17, wherein the disposing a portion of the fixing element includes disposing each of a first bending portion, a second being portion, a third bending portion and a fourth bending portion of the fixing element between the driving elements and the bottom chassis.
